(19) United States
(12) Patent Application Publication
(10) Pub. No.: US 2026/0299257 A1
(43) Pub. Date: Oct. 1, 2026

(54) OPTICAL IMAGING SYSTEM

(71) Applicant: SAMSUNG ELECTRO-MECHANICS CO., LTD., Suwon-si (KR)

(72) Inventors: Woo Young KIM, Suwon-si (KR); Tae Yeon LIM, Suwon-si (KR); Seong Il CHO, Suwon-si (KR); Jae Hyuk HUH, Suwon-si (KR)

(73) Assignee: SAMSUNG ELECTRO-MECHANICS CO., LTD., Suwon-si (KR)

(21) Appl. No.: 19/442,237

(22) Filed: Jan. 7, 2026

(30) Foreign Application Priority Data
Mar. 26, 2025 (KR) 10-2025-0038925

(51) Int. Cl. G02B 13/00; G02B 9/62; H04N 23/55

(52) U.S. Cl. CPC G02B 13/0045; G02B 9/62; G02B 13/0065; H04N 23/55

(57) ABSTRACT

An optical imaging system includes a first lens group, an optical path conversion member, and a second lens group, arranged sequentially from an object side, wherein the first lens group includes a plurality of lenses arranged along a first optical axis, and the second lens group includes a plurality of lenses arranged along a second optical axis, and wherein the optical imaging system satisfies conditional expression 3.0≤fG1/f≤4.0, where fG1 is a focal length of the first lens group and f is a focal length of the optical imaging system.

### CROSS-REFERENCE TO RELATED APPLICATIONS

This application claims the benefit under 35 USC 119(a) of Korean Patent Application No. 10-2025-0038925 filed on Mar. 26, 2025, in the Korean Intellectual Property Office, the entire disclosure of which is incorporated herein by reference for all purposes.

### BACKGROUND

### 1. Field

The present disclosure relates to an optical imaging system.

### 2. Description of the Background

Demand for telephoto camera modules capable of achieving high magnification has increased in the mobile camera market.

Consequently, camera modules having a structure of bending a path of light by disposing a reflective member, such as a prism, in front of a lens to increase the focal length without increasing a module size have been adopted.

Meanwhile, even the aforementioned structure may still have problems requiring improvement, such as low-light imaging performance, and the development of a telephoto camera to address the problems may be pursued.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group, an optical path conversion member, and a second lens group, arranged sequentially from an object side, wherein the first lens group includes a plurality of lenses arranged along a first optical axis, and the second lens group includes a plurality of lenses arranged along a second optical axis, and wherein the optical imaging system satisfies conditional expression 3.0≤fG1/f≤4.0, where fG1 is a focal length of the first lens group and f is a focal length of the optical imaging system.

The optical imaging system may satisfy conditional expression 2.0<fG1/fG2≤3.0, where fG1 is the focal length of the first lens group, and fG2 is a focal length of the second lens group.

The optical imaging system may satisfy conditional expression 2≤h1/h2≤3, where h1 is a maximum height of the optical imaging system in a first optical axis direction and h2 is a maximum height of the second lens group in the first optical axis direction.

The optical imaging system may satisfy conditional expression 0.5≤h2/Fno≤2 (unit: mm), where h2 is a maximum height of the second lens group in a first optical axis direction and Fno is an F-number of the optical imaging system.

The optical imaging system may satisfy conditional expression 0.3≤dG1G2/OAL≤0.5, where dG1G2 is a distance on an optical axis between the first lens group and the second lens group, and OAL is a distance on the optical axis from an object-side surface of a frontmost lens to an image plane.

The first lens group and the second lens group may include the same number of lenses.

The plurality of lenses arranged along the first optical axis and the plurality of lenses arranged along the second optical axis may include a first lens, a second lens, a third lens, a fourth lens, a fifth lens, and a sixth lens arranged sequentially from the object side. The optical path conversion member may be disposed between the third lens and the fourth lens.

The optical imaging system may satisfy conditional expression 0.5≤|f/f1|+|f/f2|≤2.0, where f is a focal length of the optical imaging system, f1 is a focal length of the first lens, and f2 is a focal length of the second lens.

The first lens may have positive refractive power and a concave image-side surface.

The second lens may have negative refractive power and a concave object-side surface.

The third lens may have positive refractive power.

The fourth lens may have positive refractive power, a convex object-side surface, and a convex image-side surface.

The fifth lens may have negative refractive power and a convex object-side surface.

The sixth lens may have positive refractive power.

The sixth lens may have a convex object-side surface and a concave image-side surface.

The second lens group may include a D-cut lens.

Other features and aspects will be apparent from the following detailed description, the drawings, and the claims.

### BRIEF DESCRIPTION OF DRAWINGS

FIG. 1A is a schematic diagram of an optical imaging system according to a first embodiment of the present disclosure.

FIG. 1B is a graph illustrating the aberration characteristics of the optical imaging system of FIG. 1A.

FIG. 2A is a schematic diagram of an optical imaging system according to a second embodiment of the present disclosure.

FIG. 2B is a graph illustrating the aberration characteristics of the optical imaging system of FIG. 2A.

FIG. 3A is a schematic diagram of an optical imaging system according to a third embodiment of the present disclosure.

FIG. 3B is a graph illustrating the aberration characteristics of the optical imaging system of FIG. 3A.

FIG. 4A is a schematic diagram of an optical imaging system according to a fourth embodiment of the present disclosure.

FIG. 4B is a graph illustrating the aberration characteristics of the optical imaging system of FIG. 4A.

FIG. 5A is a schematic diagram of an optical imaging system according to a fifth embodiment of the present disclosure.

FIG. 5B is a graph illustrating the aberration characteristics of the optical imaging system of FIG. 5A.

FIG. 6A is a schematic diagram of an optical imaging system according to a sixth embodiment of the present disclosure.

FIG. 6B is a graph illustrating the aberration characteristics of the optical imaging system of FIG. 6A.

FIG. 7A is a schematic diagram of an optical imaging system according to a seventh embodiment of the present disclosure.

FIG. 7B is a graph illustrating the aberration characteristics of the optical imaging system of FIG. 7A.

FIG. 8A is a schematic diagram of an optical imaging system according to an eighth embodiment of the present disclosure.

FIG. 8B is a graph illustrating the aberration characteristics of the optical imaging system of FIG. 8A.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, embodiments of the present disclosure will be described in detail with reference to the accompanying drawings. However, the scope of the present disclosure is not limited to the presented embodiments.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In the accompanying drawings, the thickness, size, and shape of lenses are somewhat exaggerated for illustrative purposes. The spherical or aspherical shape of the lenses is also provided as an example and is not limited to the shapes shown in the drawings.

An aspect of the present disclosure is to provide an optical imaging system having improved imaging performance, such as image quality and brightness.

The optical imaging system according to embodiments of the present disclosure may be mounted on a portable electronic device. For example, the optical imaging system may form a portion of a camera module mounted on a portable electronic device, and the portable electronic device may be a smartphone, tablet PC, or the like.

In this specification, a first lens (or the frontmost lens) refers to a lens closest to an object side, and the last lens (or the rearmost lens) refers to a lens closest to an imaging plane of an image sensor. Here, the imaging plane refers to a virtual plane in which the optical imaging system focuses or one surface of an image sensor in which light is received.

Also, in the description of each lens, a first surface refers to a surface closer to the object side (or an object-side surface), and a second surface refers to a surface closer to an image side (or an image-side surface).

In addition, in the description of the shape of each lens, a convex shape on one surface means that the corresponding surface is convex in a paraxial region (a very narrow region near and including the optical axis), and a concave shape on one surface means that the corresponding surface is concave in the paraxial region.

In addition, in this specification, numerical values, such as the radius of curvature, thickness, distance, and focal length of a lens are all expressed in millimeters (mm), and the field of view (FOV) is expressed in degrees (°).

An optical imaging system according to embodiments of the present disclosure includes a plurality of lens groups. For example, the optical imaging system may include a first lens group and a second lens group.

In embodiments, the first lens group and the second lens group may each include one or more lenses. For example, the first lens group and the second lens group may each include three lenses. Therefore, the optical imaging system may include six lenses.

In embodiments, the optical imaging system may include a first lens, a second lens, a third lens, a fourth lens, a fifth lens, and a sixth lens, arranged sequentially from the object side.

Each lens may be spaced apart from one another by a predetermined distance.

The optical imaging system according to embodiments of the present disclosure may include a lens formed of plastic. For example, the first through sixth lenses may all be formed of plastic.

The optical imaging system according to embodiments of the present disclosure may include a lens having at least one aspherical surface. For example, at least one of the first through sixth lenses may have at least one aspherical surface among the first and second surfaces. The aspherical surface of the lens is expressed by Mathematical Formula 1.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} … \qquad [ Mathematical Formula 1 ]$$

In Mathematical Formula 1, c is the reciprocal of the radius of curvature of the lens, K is the conic constant, and Y represents the distance from any point on the aspherical surface of the lens to the optical axis. In addition, constants A through H, J, and L through P are aspherical constants from the 4th to the 30th order, respectively, and Z (or SAG) represents the distance in the optical axis between any point on the aspherical surface and the vertex of the corresponding aspherical surface.

The optical imaging system according to embodiments of the present disclosure may include an optical path conversion member converting an optical path. For example, the optical path conversion member may be a member having a reflective surface, such as a mirror or a prism.

In embodiments, the optical path conversion member may be disposed between the first lens group and the second lens group. Accordingly, the optical axes of the first lens group and the second lens group may be different. For example, the lenses of the first lens group may be disposed along a first optical axis and the lenses of the second lens group may be disposed along a second optical axis. The first and second optical axes may be approximately perpendicular to each other.

According to embodiments, by bending the optical path through the optical path conversion member, a relatively long optical path may be formed within a limited space.

Therefore, the optical imaging system may be manufactured to be compact, while having a long focal length.

The optical imaging system according to embodiments of the present disclosure may further include an image sensor converting light reflected from a subject into an electrical signal.

In addition, the optical imaging system may further include an infrared cut filter (hereinafter, “filter”) for blocking infrared light incident on the image sensor. The filter may be disposed between the sixth lens and the image sensor.

In addition, the optical imaging system may further include a stop for controlling the amount of light. For example, the stop may be disposed between the fifth lens and the sixth lens.

The optical imaging system according to embodiments of the present disclosure may satisfy one or more of the following conditional expressions:

$$0.5 \leq \vert f / f 1 \vert + \vert f / f 2 \vert \leq 2. \qquad [ Conditional Expression 1 ]$$

$$3. \leq fG 1 / f \leq 4. \qquad [ Conditional Expression 2 ]$$

$$2. < fG 1 / fG 2 \leq 3. \qquad [ Conditional Expression 3 ]$$

$$2 \leq h 1 / h 2 \leq 3 \qquad [ Conditional Expression 4 ]$$

$$0.3 \leq dG 1 G 2 / OAL \leq 0.5 \qquad [ Conditional Expression 5 ]$$

$$0.5 \leq h 2 / Fno \leq 2 ( \text{Unit:} mm ) \qquad [ Conditional Expression 6 ]$$

In the conditional expressions, f is a total focal length of the optical imaging system, f1 is a focal length of the first lens, f2 is a focal length of the second lens, fG1 is a focal length of the first lens group, fG2 is a focal length of the second lens group, h1 is the maximum height of the optical imaging system along the first optical axis, h2 is the maximum height of the second lens group along the first optical axis, dG1G2 is a distance on the optical axis between the first lens group and the second lens group, OAL is a distance on the optical axis from an object-side surface of the first lens (the frontmost lens) to an image plane, and Fno is the F-number of the optical imaging system.

In the conditional expressions, [Conditional Expression 1] represents the focal length condition of the first lens group, i.e., the first and second lenses, for reducing aberrations. [Conditional Expressions 2] and [Conditional Expressions 3] represent the focal length conditions of the first and second lens groups for reducing the size of the second lens group. [Conditional Expression 4]relates to the design feature of a relatively low module (e.g., camera) height relative to the optical performance of the optical imaging system. [Conditional Expression 5] represents the arrangement condition of the first and second lens groups for reducing the module (e.g., camera) height. [Conditional Expression 6] represents the brightness performance relative to the size of the optical imaging system.

According to embodiments of the present disclosure, the first lens group may include three lenses, for example, a first lens, a second lens, and a third lens. For example, the first lens may have positive refractive power, the second lens may have negative refractive power, and the third lens may have positive refractive power. The first lens group as a whole may have positive refractive power. Accordingly, light passing through the first lens group may be refracted to converge and enter the optical path conversion member.

According to embodiments of the present disclosure, the second lens group may include three lenses, for example, a fourth lens, a fifth lens, and a sixth lens. For example, the fourth lens may have positive refractive power, and the fifth lens may have negative refractive power, and the sixth lens may have positive refractive power. The second lens group as a whole may have positive refractive power.

### First Embodiment

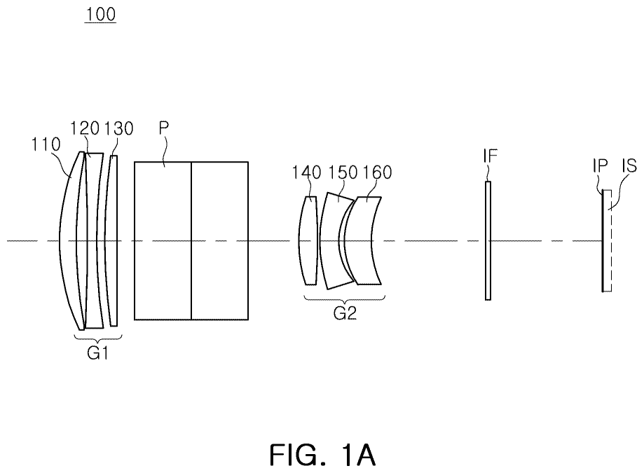

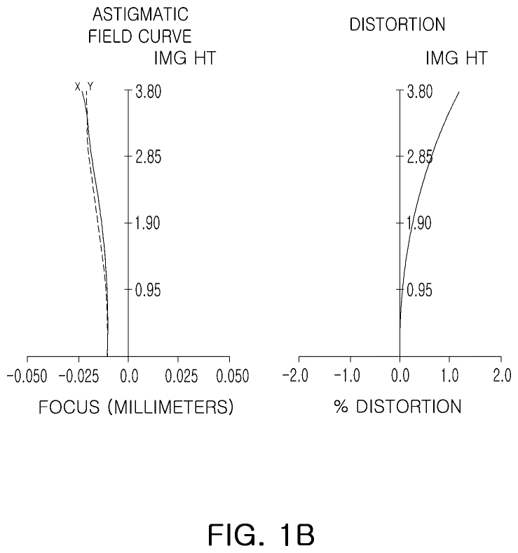

FIG. 1A is a schematic diagram of an optical imaging system according to a first embodiment of the present disclosure, and FIG. 1B is a graph illustrating aberration characteristics of the optical imaging system of FIG. 1A.

An optical imaging system 100 according to the first embodiment of the present disclosure may include a first lens group G1, an optical path conversion member P, and a second lens group G2, arranged sequentially from the object side.

The first lens group G1 may include a first lens 110, a second lens 120, and a third lens 130, arranged sequentially from the object side. The second lens group G2 may include a fourth lens 140, a fifth lens 150, and a sixth lens 160.

Also, the optical imaging system 100 may further include a filter IF and an image sensor IS having an imaging plane IP.

The optical path conversion member P may be disposed between the first lens group G1 and the second lens group G2, for example, between the third lens 130 and the fourth lens 140.

For example, the optical path conversion member P may be provided as a prism including a reflective surface.

The physical and optical characteristics of the optical elements constituting the optical imaging system 100 according to the first embodiment of the present disclosure are shown in Table 1 below.

[TABLE 1]

| | | | | | | Effective | radius of |
|---|---|---|---|---|---|---|---|
| Surface | | Radius of | Thickness/ | Refractive | Abbe | radius of | minor axis |
| No. | Remark | curvature | distance | index | number | major axis | Effective |
| Object | | Infinity | Infinity | | | | |
| S1 | | Infinity | 0.000 | | | | |
| S2 | First lens | 8.281 | 0.730 | 1.535 | 55.74 | 4.000 | 4.000 |
| S3 | | 24.586 | 0.500 | | | 3.956 | 3.956 |
| S4 | Second lens | -69.101 | 0.401 | 1.614 | 25.94 | 3.956 | 3.956 |
| S5 | | 24.612 | 0.374 | | | 3.881 | 3.881 |
| S6 | Third lens | 43.435 | 0.495 | 1.535 | 55.74 | 3.854 | 3.854 |
| S7 | | 88.637 | 0.800 | | | 3.827 | 3.827 |
| S8 | Prism | Infinity | 2.500 | 1.717 | 29.50 | 4.000 | 2.500 |
| S9 | | Infinity | 2.500 | 1.717 | 29.50 | 4.000 | 3.535 |
| S10 | | Infinity | 2.300 | | | 4.000 | 2.500 |
| S11 | Fourth lens | 6.195 | 0.819 | 1.535 | 55.74 | 2.451 | 2.000 |
| S12 | | -17.584 | 0.100 | | | 2.363 | 2.000 |
| S13 | Fifth lens | 5.661 | 0.846 | 1.614 | 25.94 | 2.202 | 2.000 |
| S14 | (Stop) | 2.266 | 0.214 | | | 1.846 | 1.846 |
| S15 | Sixth lens | 3.368 | 1.200 | 1.661 | 20.38 | 2.000 | 2.000 |
| S16 | | 4.032 | 5.085 | | | 1.948 | 1.948 |
| S17 | Filter | Infinity | 0.210 | | | | |
| S18 | | Infinity | 5.012 | | | | |
| S19 | Imaging plane | Infinity | 0.010 | | | | |

In the first embodiment of the present disclosure, the first lens 110 may have positive refractive power, a first surface of the first lens 110 may be convex, and a second surface of the first lens 110 may be concave. The second lens 120 may have negative refractive power, and both a first surface and a second surface of the second lens 120 may be concave. The third lens 130 may have positive refractive power, a first surface of the third lens 130 may be convex, and a second surface of the third lens 130 may be concave. The fourth lens 140 may have positive refractive power, and both a first surface and a second surface of the fourth lens 140 may be convex. The fifth lens 150 may have negative refractive power, a first surface of the fifth lens 150 may be convex, and a second surface of the fifth lens 150 may be concave. The sixth lens 160 may have positive refractive power, and a first surface of the sixth lens 160 may be convex and a second surface of the sixth lens 160 may be concave.

According to the first embodiment of the present disclosure, the second lens group G2 may include a D-cut lens. For example, the fourth lens 140 and the fifth lens 150 may each be provided as a D-cut lens. A D-cut lens is a lens with a portion of an edge thereof cut off, including a pair of arc portions and a straight portion connecting the pair of arc portions. The D-cut lens has a major axis and a minor axis, and an effective radius of the major axis refers to a straight-line distance from the center of the lens to the arc portion, and an effective radius of the minor axis refers to a straight-line distance from the center of the lens to the straight portion.

Aspheric data for the individual lenses constituting the optical imaging system 100 according to the first embodiment of the present disclosure are as shown in Table 2 below. According to the first embodiment, the first and second surfaces of the first lens 110 to the sixth lens 160 may all be aspherical.

[TABLE 2]

| Remark | S2 | S3 | S4 | S5 | S6 | S7 |
|---|---|---|---|---|---|---|
| K | -0.842 | 23.464 | 64.093 | -16.459 | 53.126 | -99.000 |
| A | -1.531E-04 | -1.052E-04 | 1.078E-05 | -9.985E-05 | 1.856E-04 | -1.530E-04 |
| B | -9.107E-06 | 9.216E-07 | -1.593E-06 | 2.984E-07 | 9.631E-06 | -1.238E-05 |
| C | -3.233E-07 | -7.130E-08 | -8.273E-08 | 1.655E-07 | 1.238E-07 | -1.681E-07 |
| D | 0.000E+00 | 0.000E+00 | 0.000E+00 | 0.000E+00 | 0.000E+00 | 0.000E+00 |
| E | 0.000E+00 | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |
| Remark | S11 | S12 | S13 | S14 | S15 | S16 |
| K | 0.000 | 0.158 | -11.834 | -1.479 | -1.019 | -8.235 |
| A | 8.350E-04 | 4.353E-01 | -8.979E-05 | -6.208E-02 | 7.002E-04 | 1.792E-01 |
| B | -1.116E-04 | -6.341E-01 | 2.293E-06 | 7.338E-02 | 1.405E-04 | -1.764E-01 |
| C | 2.001E-06 | 2.176E-01 | -1.491E-06 | 1.528E-01 | 7.873E-05 | 1.902E-01 |
| D | 2.394E-06 | 3.266E+00 | -2.290E-06 | -6.676E-01 | 1.084E-05 | -3.037E-01 |
| E | 0.000E+00 | -1.405E+01 | 0.000E+00 | 1.465E+00 | -1.647E-06 | 5.449E-01 |
| F | 0.000E+00 | 3.596E+01 | 0.000E+00 | -1.963E+00 | -7.272E-07 | -7.435E-01 |
| G | 0.000E+00 | -5.765E+01 | 0.000E+00 | 1.582E+00 | -1.531E-07 | 6.442E-01 |
| H | 0.000E+00 | 5.200E+01 | 0.000E+00 | -7.066E-01 | 7.105E-08 | -3.151E-01 |
| J | 0.000E+00 | -1.999E+01 | 0.000E+00 | 1.358E-01 | -3.909E-10 | 6.578E-02 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Second Embodiment

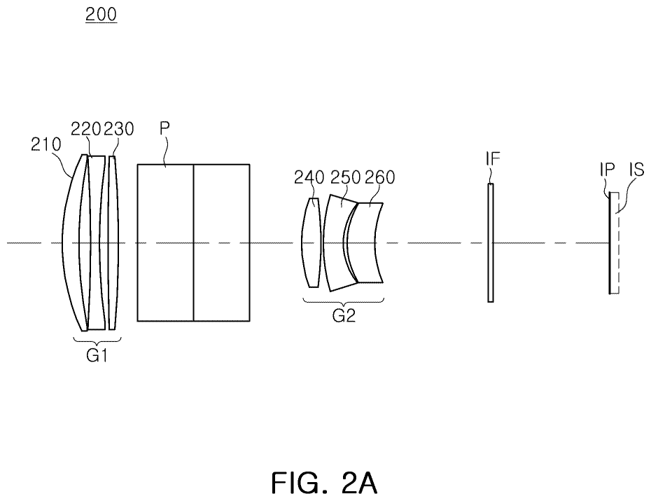

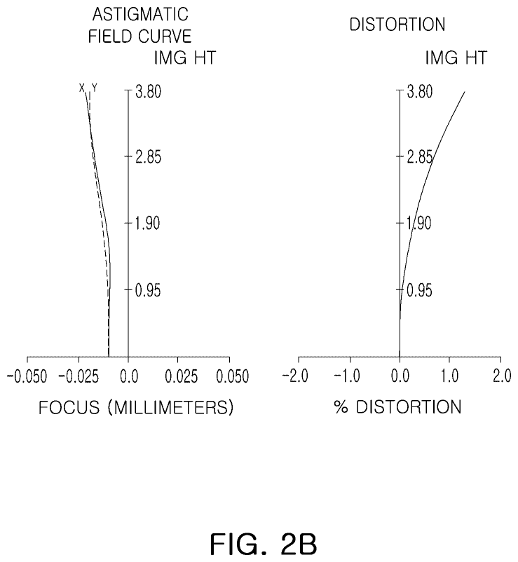

FIG. 2A is a schematic diagram of an optical imaging system according to a second embodiment of the present disclosure, and FIG. 2B is a graph illustrating the aberration characteristics of the optical imaging system of FIG. 2A.

An optical imaging system 200 according to the second embodiment of the present disclosure may include a first lens group G1, an optical path conversion member P, and a second lens group G2, arranged sequentially from the object side.

The first lens group G1 may include a first lens 210, a second lens 220, and a third lens 230, arranged sequentially from the object side. The second lens group G2 may include a fourth lens 240, a fifth lens 250, and a sixth lens 260.

Also, the optical imaging system 200 may further include a filter IF and an image sensor IS having an imaging plane IP.

The optical path conversion member P may be disposed between the first lens group G1 and the second lens group G2, for example, between the third lens 230 and the fourth lens 240.

For example, the optical path conversion member P may be configured as a prism including a reflective surface.

The physical and optical characteristics of the optical elements constituting the optical imaging system 200 according to the second embodiment of the present disclosure are shown in Table 3 below.

[TABLE 3]

| | | | | | | Effective | Effective |
|---|---|---|---|---|---|---|---|
| Surface | | Radius of | Thickness/ | Refractive | Abbe | radius of | radius of |
| No. | Remark | curvature | distance | index | number | major axis | minor axis |
| Object | | Infinity | Infinity | | | | |
| S1 | | Infinity | 0.000 | | | | |
| S2 | First lens | 8.325 | 0.729 | 1.535 | 55.74 | 4.000 | 4.000 |
| S3 | | 24.799 | 0.500 | | | 3.957 | 3.957 |
| S4 | Second lens | -72.295 | 0.400 | 1.614 | 25.94 | 3.957 | 3.957 |
| S5 | | 23.892 | 0.399 | | | 3.892 | 3.892 |
| S6 | Third lens | -162.350 | 0.472 | 1.535 | 55.74 | 3.880 | 3.880 |
| S7 | | -57.495 | 0.800 | | | 3.862 | 3.862 |
| S8 | Prism | Infinity | 2.500 | 1.717 | 29.50 | 4.000 | 2.500 |
| S9 | | Infinity | 2.500 | 1.717 | 29.50 | 4.000 | 3.535 |
| S10 | | Infinity | 2.300 | | | 4.000 | 2.500 |
| S11 | Fourth lens | 6.421 | 0.860 | 1.535 | 55.74 | 2.451 | 2.000 |
| S12 | | -15.867 | 0.100 | | | 2.363 | 2.000 |
| S13 | Fifth lens | 5.674 | 0.868 | 1.614 | 25.94 | 2.202 | 2.000 |
| S14 | (Stop) | 2.279 | 0.200 | | | 1.839 | 1.839 |
| S15 | Sixth lens | 3.384 | 1.200 | 1.661 | 20.38 | 1.849 | 1.849 |
| S16 | | 4.020 | 5.085 | | | 1.755 | 1.755 |
| S17 | Filter | Infinity | 0.210 | | | | |
| S18 | | Infinity | 5.107 | | | | |
| S19 | Imaging plane | Infinity | 0.010 | | | | |

In the second embodiment of the present disclosure, the first lens 210 may have positive refractive power, a first surface of the first lens 210 may be convex, and a second surface of the first lens 210 may be concave. The second lens 220 may have negative refractive power, and both a first surface and a second surface of the second lens 220 may be concave. The third lens 230 may have positive refractive power, a first surface of the third lens 230 may be concave, and a second surface of the third lens 230 may be convex. The fourth lens 240 may have positive refractive power, and both a first surface and a second surface of the fourth lens 240 may be convex. The fifth lens 250 may have negative refractive power, a first surface of the fifth lens 250 may be convex, and a second surface of the fifth lens 250 may be concave. The sixth lens 260 may have positive refractive power, a first surface of the six lens 260 may be convex, and a second surface of the sixth lens 260 may be concave.

According to the second embodiment of the present disclosure, the second lens group G2 may include a D-cut lens. For example, the fourth lens 240 and the fifth lens 250 may each be provided as a D-cut lens.

Aspheric data for the individual lenses constituting the optical imaging system 200 according to the second embodiment of the present disclosure are shown in Table 4 below. According to the second embodiment, the first and second surfaces of the first lens 210 to the sixth lens 260 may all be aspherical.

TABLE 4

| Remark | S2 | S3 | S4 | S5 | S6 | S7 |
|---|---|---|---|---|---|---|
| K | −0.833 | 23.856 | 77.539 | −17.237 | −99.000 | 40.952 |
| A | −1.511E−04 | −1.232E−04 | 19.905E−06 | −1.079E−04 | 1.526E−04 | −1.594E−04 |
| B | −8.844E−06 | 4.546E−08 | −2.781E−06 | −1.067E−06 | 1.291E−05 | −8.224E−06 |
| C | −3.913E−07 | −2.647E−08 | −2.777E−07 | 1.878E−08 | 2.909E−07 | −1.530E−07 |
| D | 0.000E+00 | 0.000E+00 | 0.000E+00 | 0.000E+00 | 0.000E+00 | 0.000E+00 |
| E | 0.000E+00 | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

| Remark | S11 | S12 | S13 | S14 | S15 | S16 |
|---|---|---|---|---|---|---|
| K | 0.000 | 0.158 | −11.827 | −1.487 | −0.998 | −8.103 |
| A | 8.310E−04 | 4.331E−01 | −7.702E−05 | −6.312E−02 | 7.680E−04 | 1.199E−01 |
| B | −1.089E−04 | −6.051E−01 | 2.971E−06 | 6.744E−02 | 1.505E−04 | −9.330E−02 |
| C | 2.148E−06 | −1.748E−01 | −3.125E−06 | 1.856E−01 | 8.031E−05 | 8.872E−02 |
| D | 2.337E−06 | 5.589E+00 | −3.167E−06 | −7.674E−01 | 1.113E−05 | −1.525E−01 |
| E | 0.000E+00 | −2.297E+01 | 0.000E+00 | 1.659E+00 | −1.578E−06 | 2.742E−01 |
| F | 0.000E+00 | 5.687E+01 | 0.000E+00 | −2.196E+00 | −7.054E−07 | −3.426E−01 |
| G | 0.000E+00 | −8.653E+01 | 0.000E+00 | 1.748E+00 | −1.451E−07 | 2.621E−01 |
| H | 0.000E+00 | 7.344E+01 | 0.000E+00 | −7.697E−01 | 7.402E−08 | −1.101E−01 |
| J | 0.000E+00 | −2.652E+01 | 0.000E+00 | 1.455E−01 | −3.909E−10 | 1.924E−02 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Third Embodiment

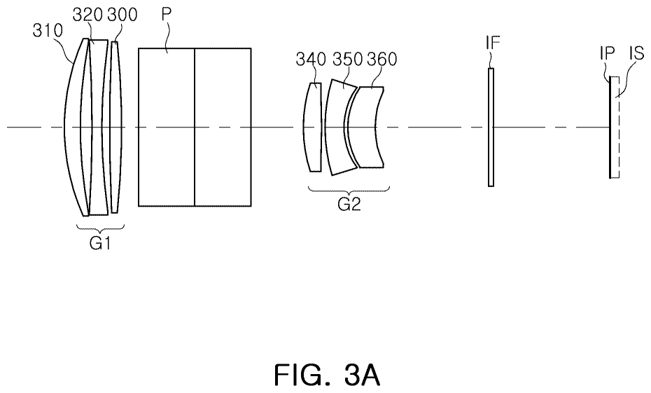

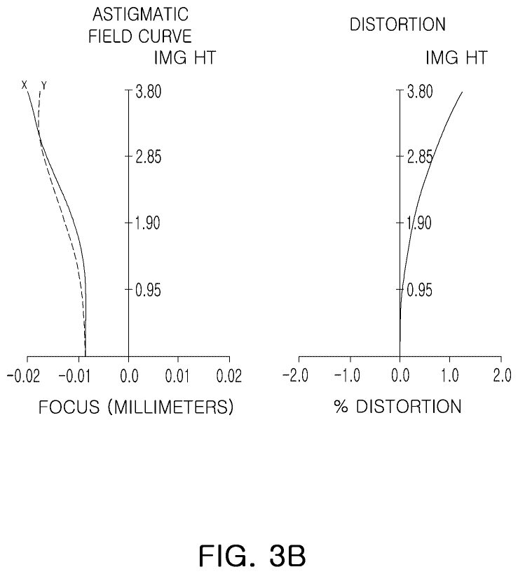

FIG. 3A is a schematic diagram of an optical imaging system according to a third embodiment of the present disclosure, and FIG. 3B is a graph illustrating the aberration characteristics of the optical imaging system of FIG. 3A.

An optical imaging system 300 according to the third embodiment of the present disclosure may include a first lens group G1, an optical path conversion member P, and a second lens group G2, arranged sequentially from the object side.

The first lens group G1 may include a first lens 310, a second lens 320, and a third lens 330, arranged sequentially from the object side. The second lens group G2 may include a fourth lens 340, a fifth lens 350, and a sixth lens 360.

In addition, the optical imaging system 300 may further include a filter IF and an image sensor IS having an imaging plane IP.

The optical path conversion member P may be disposed between the first lens group G1 and the second lens group G2, for example, between the third lens 330 and the fourth lens 340.

For example, the optical path conversion member P may be configured as a prism including a reflective surface.

The physical and optical characteristics of the optical elements constituting the optical imaging system 300 according to the third embodiment of the present disclosure are shown in Table 5 below.

TABLE 5

| | | | | | | Effective | Effective |
|---|---|---|---|---|---|---|---|
| Surface | | Radius of | Thickness/ | Refractive | Abbe | radius of | radius of |
| No. | Remark | curvature | distance | index | number | major axis | minor axis |
| Object | | Infinity | Infinity | | | | |
| S1 | | Infinity | 0.000 | | | | |
| S2 | First lens | 8.316 | 0.733 | 1.535 | 55.74 | 4.000 | 4.000 |
| S3 | | 25.037 | 0.500 | | | 3.957 | 3.957 |
| S4 | Second | −70.695 | 0.409 | 1.614 | 25.94 | 3.957 | 3.957 |
| | lens | | | | | | |
| S5 | | 23.852 | 0.388 | | | 3.892 | 3.892 |
| S6 | Third lens | −297.336 | 0.470 | 1.544 | 55.99 | 3.879 | 3.879 |
| S7 | | −68.760 | 0.800 | | | 3.860 | 3.860 |
| S8 | Prism | Infinity | 2.500 | 1.717 | 29.50 | 4.000 | 2.500 |
| S9 | | Infinity | 2.500 | 1.717 | 29.50 | 4.000 | 3.535 |
| S10 | | Infinity | 2.300 | | | 4.000 | 2.500 |
| S11 | Fourth | 6.532 | 0.837 | 1.535 | 55.74 | 2.451 | 2.000 |
| | lens | | | | | | |
| S12 | | −14.956 | 0.100 | | | 2.363 | 2.000 |
| S13 | Fifth lens | 5.724 | 0.848 | 1.614 | 25.94 | 2.202 | 2.000 |
| S14 | (Stop) | 2.277 | 0.186 | | | 1.841 | 1.841 |
| S15 | Sixth lens | 3.300 | 1.200 | 1.661 | 20.38 | 1.851 | 1.851 |
| S16 | | 3.910 | 5.085 | | | 1.755 | 1.755 |
| S17 | Filter | Infinity | 0.210 | | | | |
| S18 | | Infinity | 5.124 | | | | |
| S19 | Imaging | Infinity | 0.009 | | | | |
| | plane | | | | | | |

In the third embodiment of the present disclosure, the first lens 310 may have positive refractive power, a first surface of the first lens 310 may be convex, and a second surface of the first lens 310 may be concave. The second lens 320 may have negative refractive power, and both a first surface and a second surface of the second lens 320 may be concave. The third lens 330 may have positive refractive power, a first surface of the third lens 330 may be concave, and a second surface of the third lens 330 may be convex. The fourth lens 340 may have positive refractive power, and both a first surface and a second surface of the fourth lens 340 may be convex. The fifth lens 350 may have negative refractive power, a first surface of the fifth lens 350 may be convex, and a second surface of the fifth lens 350 may be concave. The sixth lens 360 may have positive refractive power, a first surface of the six lens 360 may be convex, and a second surface of the sixth lens 360 may be concave.

According to the third embodiment of the present disclosure, the second lens group G2 may include a D-cut lens. For example, the fourth lens 340 and the fifth lens 350 may each be provided as a D-cut lens.

Aspheric data for the individual lenses constituting the optical imaging system 300 according to the third embodiment of the present disclosure are shown in Table 6 below. According to the third embodiment, the first and second surfaces of the first lens 310 to the sixth lens 360 may all be aspherical.

TABLE 6

| Remark | S2 | S3 | S4 | S5 | S6 | S7 |
|---|---|---|---|---|---|---|
| K | −0.859 | 24.343 | 83.146 | −17.457 | −99.000 | 45.918 |
| A | −1.568E−04 | −1.348E−04 | 7.818E−06 | −1.089E−04 | 1.610E−04 | −1.632E−04 |
| B | −9.568E−06 | −8.528E−08 | −2.773E−06 | −1.482E−06 | 1.295E−05 | −8.076E−06 |
| C | −3.896E−07 | −3.792E−08 | −2.907E−07 | −2.383E−08 | 2.742E−07 | −1.304E−07 |
| D | 0.000E+00 | 0.000E+00 | 0.000E+00 | 0.000E+00 | 0.000E+00 | 0.000E+00 |
| E | 0.000E+00 | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

| Remark | S11 | S12 | S13 | S14 | S15 | S16 |
|---|---|---|---|---|---|---|
| K | 0.000 | 0.158 | −12.186 | −1.484 | −0.999 | −7.966 |
| A | 8.333E−04 | 4.317E−01 | −1.726E−04 | −6.254E−02 | 7.645E−04 | 1.253E−01 |
| B | −1.069E−04 | −6.055E−01 | −8.870E−06 | 7.023E−02 | 1.483E−04 | −1.019E−01 |
| C | 2.848E−06 | −1.803E−01 | −2.760E−06 | 1.641E−01 | 8.161E−05 | 1.004E−01 |
| D | 2.320E−06 | 5.647E+00 | −2.697E−06 | −6.956E−01 | 1.164E−05 | −1.636E−01 |
| E | 0.000E+00 | −2.271E+01 | 0.000E+00 | 1.515E+00 | −1.474E−06 | 2.780E−01 |
| F | 0.000E+00 | 5.520E+01 | 0.000E+00 | −2.020E+00 | −6.951E−07 | −3.346E−01 |
| G | 0.000E+00 | −8.319E+01 | 0.000E+00 | 1.623E+00 | −1.469E−07 | 2.497E−01 |
| H | 0.000E+00 | 7.056E+01 | 0.000E+00 | −7.237E−01 | 7.283E−08 | −1.034E−01 |
| J | 0.000E+00 | −2.564E+01 | 0.000E+00 | 1.388E−01 | −3.909E−10 | 1.795E−02 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Fourth Embodiment

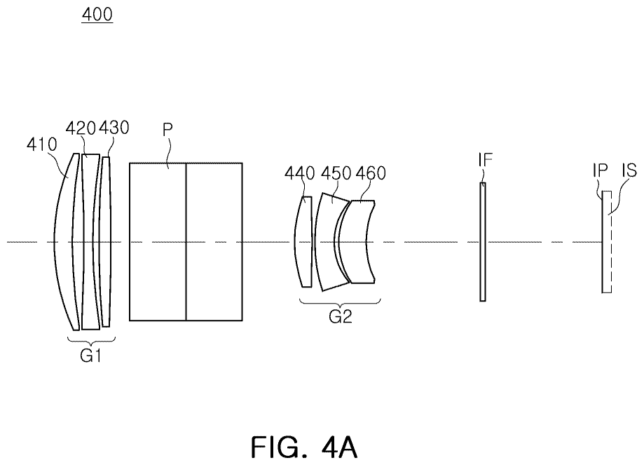

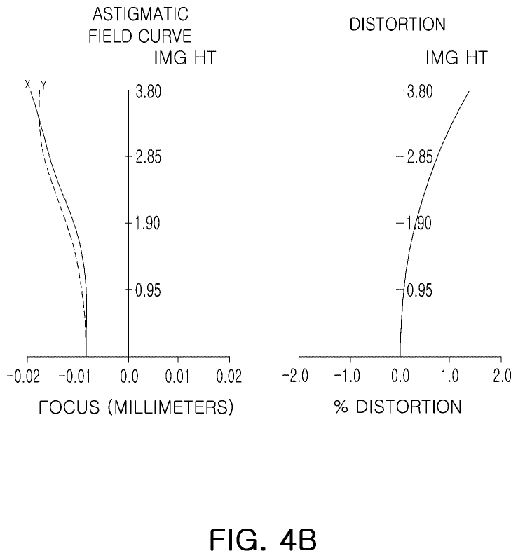

FIG. 4A is a schematic diagram of an optical imaging system according to a fourth embodiment of the present disclosure, and FIG. 4B is a graph illustrating the aberration characteristics of the optical imaging system of FIG. 4A.

An optical imaging system 400 according to the fourth embodiment of the present disclosure may include a first lens group G1, an optical path conversion member P, and a second lens group G2, arranged sequentially from the object side.

The first lens group G1 may include a first lens 410, a second lens 420, and a third lens 430, arranged sequentially from the object side. The second lens group G2 may include a fourth lens 440, a fifth lens 450, and a sixth lens 460.

In addition, the optical imaging system 400 may further include a filter IF and an image sensor IS having an imaging plane IP.

The optical path conversion member P may be disposed between the first lens group G1 and the second lens group G2, for example, between the third lens 430 and the fourth lens 440.

For example, the optical path conversion member P may be configured as a prism including a reflective surface.

The physical and optical characteristics of the optical elements constituting the optical imaging system 400 according to the fourth embodiment of the present disclosure are as shown in Table 7 below.

TABLE 7

| | | | | | | Effective | |
|---|---|---|---|---|---|---|---|
| Surface | | Radius of | Thickness/ | Refractive | Abbe | radius of | radius of |
| No. | Remark | curvature | distance | index | number | major axis | Effective minor axis |
| Object | | Infinity | Infinity | | | | |
| S1 | | Infinity | 0.000 | | | | |
| S2 | First lens | 8.401 | 0.800 | 1.535 | 55.74 | 4.000 | 4.000 |
| S3 | | 26.851 | 0.500 | | | 3.948 | 3.948 |
| S4 | Second | −72.764 | 0.400 | 1.614 | 25.94 | 3.931 | 3.931 |
| | lens | | | | | | |
| S5 | | 23.128 | 0.302 | | | 3.852 | 3.852 |
| S6 | Third lens | 198.764 | 0.497 | 1.544 | 55.99 | 3.838 | 3.838 |
| S7 | | −233.975 | 0.800 | | | 3.807 | 3.807 |
| S8 | Prism | Infinity | 2.500 | 1.717 | 29.50 | 4.000 | 2.500 |
| S9 | | Infinity | 2.500 | 1.717 | 29.50 | 4.000 | 3.535 |
| S10 | | Infinity | 2.300 | | | 4.000 | 2.500 |
| S11 | Fourth | 6.507 | 0.826 | 1.535 | 55.74 | 2.451 | 2.000 |
| | lens | | | | | | |
| S12 | | −15.006 | 0.100 | | | 2.363 | 2.000 |
| S13 | Fifth lens | 5.731 | 0.857 | 1.614 | 25.94 | 2.202 | 2.000 |
| S14 | (Stop) | 2.280 | 0.182 | | | 1.839 | 1.839 |
| S15 | Sixth lens | 3.302 | 1.200 | 1.661 | 20.38 | 1.848 | 1.848 |
| S16 | | 3.921 | 5.085 | | | 1.749 | 1.749 |
| S17 | Filter | Infinity | 0.210 | | | | |
| S18 | | Infinity | 5.123 | | | | |
| S19 | Imaging | Infinity | 0.009 | | | | |
| | plane | | | | | | |

In the fourth embodiment of the present disclosure, the first lens 410 may have positive refractive power, a first surface of the first lens 410 may be convex, and a second surface of the first lens 410 may be concave. The second lens 420 may have negative refractive power, and both a first surface and a second surface of the second lens 420 may be concave. The third lens 430 may have positive refractive power, and both a first surface and a second surface of the third lens 430 may be convex. The fourth lens 440 may have positive refractive power, and both a first surface and a second surface of the fourth lens 440 may be convex. The fifth lens 450 may have negative refractive power, a first surface of the fifth lens 450 may be convex, and a second surface of the fifth lens 450 may be concave. The sixth lens 460 may have positive refractive power, a first surface of the sixth lens 460 may be convex, and a second surface of the sixth lens 460 may be concave.

According to the fourth embodiment of the present disclosure, the second lens group G2 may include a D-cut lens. For example, the fourth lens 440 and the fifth lens 450 may each be provided as a D-cut lens.

Aspheric data for the individual lenses constituting the optical imaging system 400 according to the fourth embodiment of the present disclosure are shown in Table 8 below. According to the fourth embodiment, the first and second surfaces of the first lens 410 to the sixth lens 460 may all be aspherical.

TABLE 8

| Remark | S2 | S3 | S4 | S5 | S6 | S7 |
|---|---|---|---|---|---|---|
| ZK | −0.901 | 23.550 | 67.261 | −15.848 | −99.000 | 10.267 |
| A | −1.659E−04 | −1.476E−04 | 1.371E−05 | −9.806E−05 | 1.482E−04 | −1.498E−04 |
| B | −1.045E−05 | −1.027E−06 | −2.116E−06 | −8.325E−07 | 1.212E−05 | −7.361E−06 |
| C | −4.594E−07 | −1.114E−07 | −2.248E−07 | 1.002E−08 | 2.305E−07 | −9.671E−08 |
| D | 0.000E+00 | 0.000E+00 | 0.000E+00 | 0.000E+00 | 0.000E+00 | 0.000E+00 |
| E | 0.000E+00 | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

| Remark | S11 | S12 | S13 | S14 | S15 | S16 |
|---|---|---|---|---|---|---|
| K | 0.000 | 0.158 | −12.137 | −1.487 | −0.993 | −7.910 |
| A | 8.415E−04 | 4.671E−03 | −1.625E−04 | −5.520E−03 | 7.863E−04 | 1.333E−02 |
| B | −1.054E−04 | −6.882E−04 | −7.796E−06 | 1.826E−03 | 1.510E−04 | −3.405E−03 |
| C | 3.072E−06 | −2.304E−05 | −2.748E−06 | 1.211E−03 | 8.195E−05 | 1.030E−03 |
| D | 2.347E−06 | 7.272E−05 | −2.735E−06 | −1.510E−03 | 1.168E−05 | −5.120E−04 |
| E | 0.000E+00 | −3.129E−05 | 0.000E+00 | 9.666E−04 | −1.472E−06 | 2.736E−04 |
| F | 0.000E+00 | 8.152E−06 | 0.000E+00 | −3.791E−04 | −6.957E−07 | −1.065E−04 |
| G | 0.000E+00 | −1.314E−06 | 0.000E+00 | 8.970E−05 | −1.471E−07 | 2.615E−05 |
| H | 0.000E+00 | 1.188E−07 | 0.000E+00 | −1.179E−05 | 7.284E−08 | −3.604E−06 |
| J | 0.000E+00 | −4.589E−09 | 0.000E+00 | 6.681E−07 | −3.909E−10 | 2.096E−07 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Fifth Embodiment

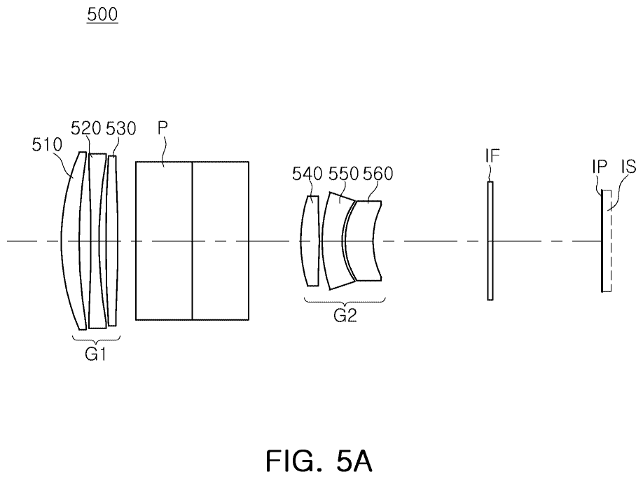

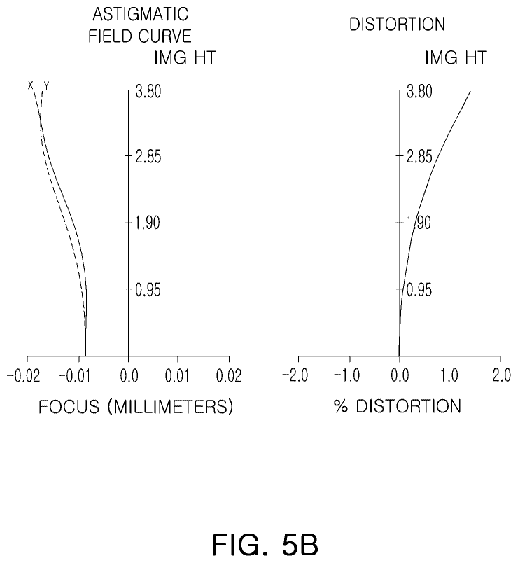

FIG. 5A is a schematic diagram of an optical imaging system according to a fifth embodiment of the present disclosure, and FIG. 5B is a graph illustrating the aberration characteristics of the optical imaging system of FIG. 5A.

An optical imaging system 500 according to the fifth embodiment of the present disclosure may include a first lens group G1, an optical path conversion member P, and a second lens group G2, arranged sequentially from the object side.

The first lens group G1 may include a first lens 510, a second lens 520, and a third lens 530, arranged sequentially from the object side. The second lens group G2 may include a fourth lens 540, a fifth lens 550, and a sixth lens 560.

In addition, the optical imaging system 500 may further include a filter IF and an image sensor IS having an imaging plane IP.

The optical path conversion member P may be disposed between the first lens group G1 and the second lens group G2, for example, between the third lens 530 and the fourth lens 540.

For example, the optical path conversion member P may be configured as a prism including a reflective surface.

The physical and optical characteristics of the optical elements constituting the optical imaging system 500 according to the fifth embodiment of the present disclosure are shown in Table 9 below.

TABLE 9

| | | | | | | Effective | Effective |
|---|---|---|---|---|---|---|---|
| Surface | | Radius of | Thickness/ | Refractive | Abbe | radius of | radius of |
| No. | Remark | curvature | distance | index | number | major axis | minor axis |
| Object | | Infinity | Infinity | | | | |
| S1 | | Infinity | 0.000 | | | | |
| S2 | First lens | 8.428 | 0.834 | 1.535 | 55.74 | 4.000 | 4.000 |
| S3 | | 27.287 | 0.500 | | | 3.942 | 3.942 |
| S4 | Second | −73.947 | 0.400 | 1.614 | 25.94 | 3.921 | 3.921 |
| | lens | | | | | | |
| S5 | | 22.800 | 0.254 | | | 3.837 | 3.837 |
| S6 | Third lens | 118.074 | 0.512 | 1.544 | 55.99 | 3.825 | 3.825 |
| S7 | | − | 0.800 | | | 3.790 | 3.790 |
| | | 1462.500 | | | | | |
| S8 | Prism | Infinity | 2.500 | 1.717 | 29.50 | 4.000 | 2.500 |
| S9 | | Infinity | 2.500 | 1.717 | 29.50 | 4.000 | 3.535 |
| S10 | | Infinity | 2.300 | | | 4.000 | 2.500 |
| S11 | Fourth | 6.570 | 0.852 | 1.544 | 55.99 | 2.451 | 2.000 |
| | lens | | | | | | |
| S12 | | −14.670 | 0.100 | | | 2.363 | 2.000 |
| S13 | Fifth lens | 5.733 | 0.853 | 1.614 | 25.94 | 2.202 | 2.000 |
| S14 | (Stop) | 2.281 | 0.183 | | | 1.834 | 1.834 |
| S15 | Sixth lens | 3.305 | 1.200 | 1.661 | 20.38 | 1.843 | 1.843 |
| S16 | | 3.895 | 5.085 | | | 1.746 | 1.746 |
| S17 | Filter | Infinity | 0.210 | 1.517 | 64.20 | | |
| S18 | | Infinity | 4.841 | | | | |
| S19 | Imaging | Infinity | 0.009 | | | | |
| | plane | | | | | | |

In the fifth embodiment of the present disclosure, the first lens 510 may have positive refractive power, a first surface of the first lens 510 may be convex, and a second surface of the first lens 510 may be concave. The second lens 520 may have negative refractive power, and both a first surface and a second surface of the second lens 520 may be concave. The third lens 530 may have positive refractive power, and a first surface and a second surface of the third lens 530 may be convex. The fourth lens 540 may have positive refractive power, and both a first surface and a second surface of the fourth lens 540 may be convex. The fifth lens 550 may have negative refractive power, a first surface of the fifth lens 550 may be convex, and a second surface of the fifth lens 550 may be concave. The sixth lens 560 may have positive refractive power, a first surface of the sixth lens 560 may be convex, and a second surface of the sixth lens 560 may be concave.

According to the fifth embodiment of the present disclosure, the second lens group G2 may include a D-cut lens. For example, the fourth lens 540 and the fifth lens 550 may each be provided as a D-cut lens.

Aspheric data for the individual lenses constituting the optical imaging system 500 according to the fifth embodiment of the present disclosure is shown in Table 10 below. According to the fifth embodiment, the first and second surfaces of the first lens 510 to the sixth lens 560 may all be aspherical.

TABLE 10

| Remark | S2 | S3 | S4 | S5 | S6 | S7 |
|---|---|---|---|---|---|---|
| K | −0.910 | 23.272 | 67.509 | −15.203 | −99.000 | 99.000 |
| A | −1.681E−04 | −1.500E−04 | 1.300E−05 | −9.382E−05 | 1.434E−04 | −1.462E−04 |
| B | −1.052E−05 | −1.212E−06 | −2.013E−06 | −6.557E−07 | 1.189E−05 | −7.396E−06 |
| C | −4.798E−07 | −1.227E−07 | −2.006E−07 | 2.096E−08 | 2.161E−07 | −1.010E−07 |
| D | 0.000E+00 | 0.000E+00 | 0.000E+00 | 0.000E+00 | 0.000E+00 | 0.000E+00 |
| E | 0.000E+00 | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

| Remark | S11 | S12 | S13 | S14 | S15 | S16 |
|---|---|---|---|---|---|---|
| K | 0.000 | 0.158 | −12.163 | −1.487 | −0.992 | −7.863 |
| A | 8.417E−04 | 4.311E−01 | −1.651E−04 | −6.345E−02 | 7.904E−04 | 1.259E−01 |
| B | −1.046E−04 | 1−6.255E−01 | −7.855E−06 | 7.282E−02 | 1.505E−04 | −1.014E−01 |
| C | 3.113E−06 | −1.253E−01 | −2.710E−06 | 1.445E−01 | 8.195E−05 | 1.082E−01 |
| D | 2.336E−06 | 5.502E+00 | −2.725E−06 | −6.104E−01 | 1.169E−05 | −1.956E−01 |
| E | 0.000E+00 | −2.197E+01 | 0.000E+00 | 1.303E+00 | −1.473E−06 | 3.392E−01 |
| F | 0.000E+00 | 5.239E+01 | 0.000E+00 | −1.703E+00 | −6.986E−07 | −4.030E−01 |
| G | 0.000E+00 | −7.713E+01 | 0.000E+00 | 1.344E+00 | −1.486E−07 | 2.955E−01 |
| H | 0.000E+00 | 6.381E+01 | 0.000E+00 | −5.890E−01 | 7.229E−08 | −1.205E−01 |
| J | 0.000E+00 | −2.261E+01 | 0.000E+00 | 1.115E−01 | −3.909E−10 | 2.071E−02 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Sixth Embodiment

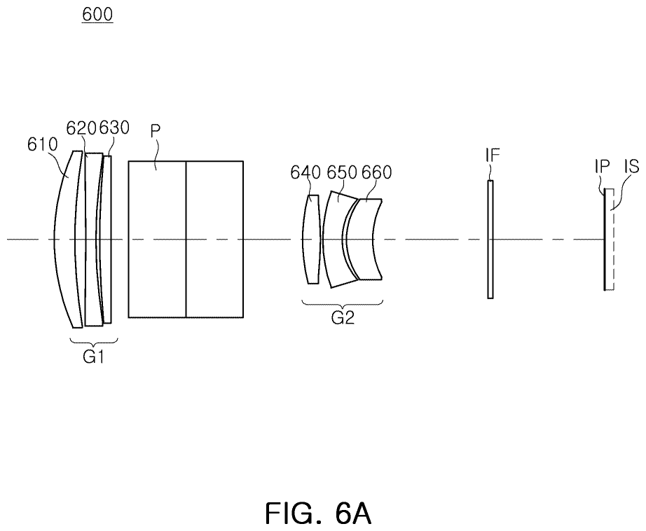

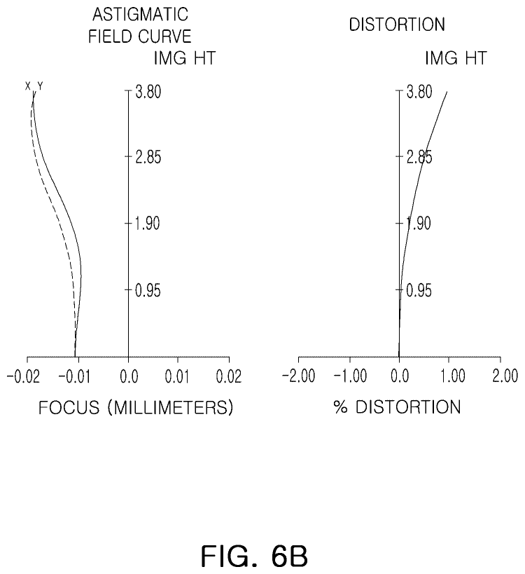

FIG. 6A is a schematic diagram of an optical imaging system according to a sixth embodiment of the present disclosure, and FIG. 6B is a graph illustrating the aberration characteristics of the optical imaging system of FIG. 6A.

An optical imaging system 600 according to the sixth embodiment of the present disclosure may include a first lens group G1, an optical path conversion member P, and a second lens group G2, arranged sequentially from the object side.

The first lens group G1 may include a first lens 610, a second lens 620, and a third lens 630, arranged sequentially from the object side. The second lens group G2 may include a fourth lens 640, a fifth lens 650, and a sixth lens 660.

In addition, the optical imaging system 600 may further include a filter IF and an image sensor IS having an imaging plane IP.

The optical path conversion member P may be disposed between the first lens group G1 and the second lens group G2, for example, between the third lens 630 and the fourth lens 650.

For example, the optical path conversion member P may be configured as a prism including a reflective surface.

The physical and optical characteristics of the optical elements constituting the optical imaging system 600 according to the sixth embodiment of the present disclosure are shown in Table 11 below.

TABLE 11

| | | | | | | Effective | Effective |
|---|---|---|---|---|---|---|---|
| Surface | | Radius of | Thickness/ | Refractive | Abbe | radius of | radius of |
| No. | Remark | curvature | distance | index | number | major axis | minor axis |
| Object | | Infinity | Infinity | | | | |
| S1 | | Infinity | 0.000 | | | | |
| S2 | First lens | 8.539 | 0.923 | 1.535 | 55.74 | 4.000 | 4.000 |
| S3 | | 24.816 | 0.500 | | | 3.942 | 3.942 |
| S4 | Second | −147.647 | 0.419 | 1.614 | 25.94 | 3.921 | 3.921 |
| | lens | | | | | | |
| S5 | | 20.881 | 0.180 | | | 3.837 | 3.837 |
| S6 | Third lens | 60.685 | 0.478 | 1.544 | 55.99 | 3.825 | 3.825 |
| S7 | | 136.108 | 0.800 | | | 3.790 | 3.790 |
| S8 | Prism | Infinity | 2.500 | 1.717 | 29.50 | 4.000 | 2.500 |
| S9 | | Infinity | 2.500 | 1.717 | 29.50 | 4.000 | 3.535 |
| S10 | | Infinity | 2.694 | | | 4.000 | 2.500 |
| S11 | Fourth | 8.451 | 0.805 | 1.544 | 55.99 | 2.451 | 2.000 |
| | lens | | | | | | |
| S12 | | −10.674 | 0.100 | | | 2.363 | 2.000 |
| S13 | Fifth lens | 5.410 | 0.852 | 1.614 | 25.94 | 2.202 | 2.000 |
| S14 | (Stop) | 2.048 | 0.137 | | | 1.834 | 1.834 |
| S15 | Sixth lens | 2.746 | 1.200 | 1.661 | 20.38 | 1.843 | 1.843 |
| S16 | | 3.745 | 5.085 | | | 1.746 | 1.746 |
| S17 | Filter | Infinity | 0.210 | 1.517 | 64.20 | | |
| S18 | | Infinity | 4.841 | | | | |
| S19 | Imaging | Infinity | 0.009 | | | | |
| | plane | | | | | | |

In the sixth embodiment of the present disclosure, the first lens 610 may have positive refractive power, a first surface of the first lens 610 may be convex, and a second surface of the first lens 610 may be concave. The second lens 620 may have negative refractive power, and both a first surface and a second surface of the second lens 620 may be concave. The third lens 630 may have positive refractive power, a first surface of the third lens 630 may be convex, and a second surface of the third lens 630 may be concave. The fourth lens 640 may have positive refractive power, and both a first surface and a second surface of the fourth lens 640 may be convex. The fifth lens 650 may have negative refractive power, a first surface of the fifth lens 650 may be convex, and a second surface of the fifth lens 650 may be concave. The sixth lens 660 may have positive refractive power, a first surface of the sixth lens 660 may be convex, and a second surface of the sixth lens 660 may be concave.

According to the sixth embodiment of the present disclosure, the second lens group G2 may include a D-cut lens. For example, the fourth lens 640 and the fifth lens 650 may each be provided as a D-cut lens.

Aspheric data for the individual lenses constituting the optical imaging system 600 according to the sixth embodiment of the present disclosure is shown in Table 12 below. According to the sixth embodiment, the first and second surfaces of the first lens 610 to the sixth lens 660 may all be aspherical.

TABLE 12

| Remark | S2 | S3 | S4 | S5 | S6 | S7 |
|---|---|---|---|---|---|---|
| K | −0.887 | 21.469 | 99.000 | −12.598 | −52.684 | −99.000 |
| A | −1.639E−04 | −1.648E−04 | −2.220E−06 | −7.031E−05 | 1.315E−04 | −1.412E−04 |
| B | −9.282E−06 | −2.114E−06 | −2.707E−06 | 3.692E−07 | 1.153E−05 | −8.902E−06 |
| C | −4.352E−07 | −1.143E−07 | −1.785E−07 | 3.931E−08 | 1.610E−07 | −2.525E−07 |
| D | 0.000E+00 | 0.000E+00 | 0.000E+00 | 0.000E+00 | 0.000E+00 | 0.000E+00 |
| E | 0.000E+00 | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

| Remark | S11 | S12 | S13 | S14 | S15 | S16 |
|---|---|---|---|---|---|---|
| K | 0.000 | 0.075 | −11.643 | −1.484 | −0.957 | −7.445 |
| A | 7.096E−04 | 4.919E−01 | −6.885E−05 | −6.754E−02 | 9.417E−04 | 1.327E−01 |
| B | −1.199E−04 | −8.421E−01 | 8.171E−06 | 8.068E−02 | 1.828E−04 | −1.083E−01 |
| C | 2.010E−06 | 8.113E−01 | 1.683E−06 | 1.981E−01 | 9.015E−05 | 1.388E−01 |
| D | 2.256E−06 | 2.028E+00 | −1.600E−06 | −9.500E−01 | 1.337E−05 | −2.951E−01 |
| E | 0.000E+00 | −1.316E+01 | 0.000E+00 | 2.270E+00 | −1.298E−06 | 5.564E−01 |
| F | 0.000E+00 | 4.032E+01 | 0.000E+00 | −3.285E+00 | −7.546E−07 | −6.863E−01 |
| G | 0.000E+00 | −7.332E+01\| | 0.000E+00 | 2.859E+00 | −1.975E−07 | 5.089E−01 |
| H | 0.000E+00 | 7.349E+01 | 0.000E+00 | −1.381E+00 | 4.830E−08 | −2.056E−01 |
| J | 0.000E+00 | −3.103E+01 | 0.000E+00 | 2.841E−01 | −3.909E−10 | 3.448E−02 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Seventh Embodiment

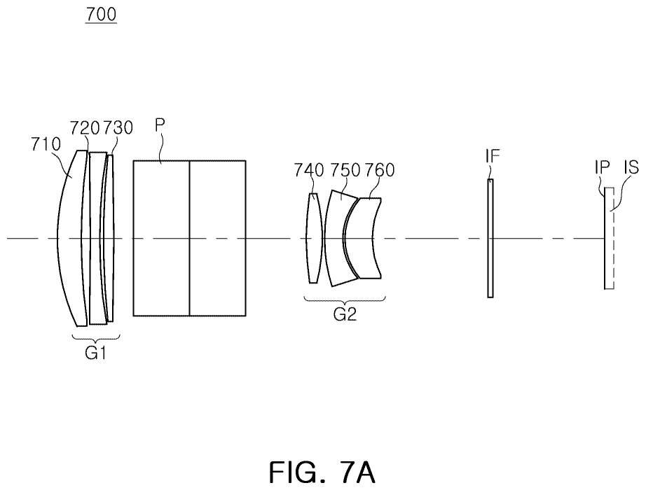

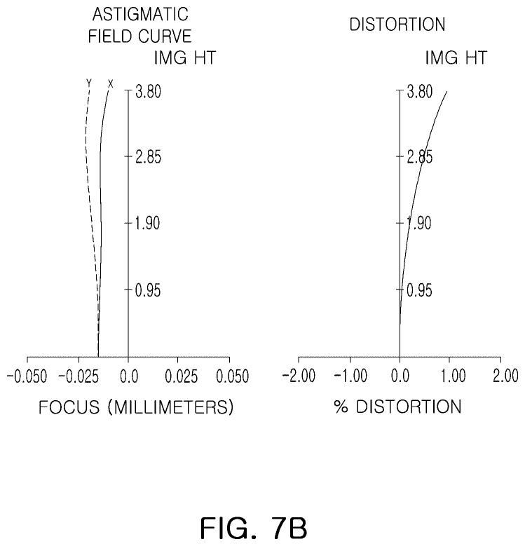

FIG. 7A is a schematic diagram of an optical imaging system according to a seventh embodiment of the present disclosure, and FIG. 7B is a graph illustrating the aberration characteristics of the optical imaging system of FIG. 7A.

An optical imaging system 700 according to the seventh embodiment of the present disclosure may include a first lens group G1, an optical path conversion member P, and a second lens group G2, arranged sequentially from the object side.

The first lens group G1 may include a first lens 710, a second lens 720, and a third lens 730, arranged sequentially from the object side. The second lens group G2 may include a fourth lens 740, a fifth lens 750, and a sixth lens 760.

In addition, the optical imaging system 700 may further include a filter IF and an image sensor IS having an imaging plane IP.

The optical path conversion member P may be disposed between the first lens group G1 and the second lens group G2, for example, between the third lens 730 and the fourth lens 740. For example, the optical path conversion member P may be configured as a prism including a reflective surface.

The physical and optical characteristics of the optical elements constituting the optical imaging system 700 according to the seventh embodiment of the present disclosure are as shown in Table 13 below.

TABLE 13

| | | | | | | Effective | |
|---|---|---|---|---|---|---|---|
| Surface | | Radius of | Thickness/ | Refractive | Abbe | radius of | radius of |
| No. | Remark | curvature | distance | index | number | major axis | Effective minor axis |
| Object | | Infinity | Infinity | | | | |
| S1 | | Infinity | 0.000 | | | | |
| S2 | First lens | 8.542 | 1.028 | 1.535 | 55.74 | 4.000 | 4.000 |
| S3 | | 26.520 | 0.440 | | | 3.901 | 3.901 |
| S4 | Second | −113.485 | 0.400 | 1.614 | 25.94 | 3.881 | 3.881 |
| | lens | | | | | | |
| S5 | | 21.626 | 0.191 | | | 3.782 | 3.782 |
| S6 | Third lens | 120.078 | 0.441 | 1.544 | 55.99 | 3.781 | 3.781 |
| S7 | | −519.185 | 0.800 | | | 3.753 | 3.753 |
| S8 | Prism | Infinity | 2.500 | 1.717 | 29.50 | 4.000 | 2.500 |
| S9 | | Infinity | 2.500 | 1.717 | 29.50 | 4.000 | 3.535 |
| S10 | | Infinity | 2.694 | | | 4.000 | 2.500 |
| S11 | Fourth | 10.488 | 0.700 | 1.544 | 55.99 | 2.451 | 2.000 |
| | lens | | | | | | |
| S12 | | −8.658 | 0.102 | | | 2.363 | 2.000 |
| S13 | Fifth lens | 5.339 | 0.798 | 1.614 | 25.94 | 2.202 | 2.000 |
| S14 | (Stop) | 1.992 | 0.114 | | | 1.821 | 1.821 |
| S15 | Sixth lens | 2.640 | 1.200 | 1.639 | 23.49 | 1.822 | 1.822 |
| S16 | | 3.712 | 5.085 | | | 1.736 | 1.736 |
| S17 | Filter | Infinity | 0.210 | 1.517 | 64.20 | | |
| S18 | | Infinity | 4.988 | | | | |
| S19 | Imaging | Infinity | 0.015 | | | | |
| | plane | | | | | | |

In the seventh embodiment of the present disclosure, the first lens 710 may have positive refractive power, a first surface of the first lens 710 may be convex, and a second surface of the first lens 710 may be concave. The second lens 720 may have negative refractive power, and both a first surface and a second surface of the second lens 720 may be concave. The third lens 730 may have positive refractive power, and both a first surface and a second surface of the third lens 730 may be convex. The fourth lens 740 may have positive refractive power, and both a first surface and a second surface of the fourth lens 740 may be convex. The fifth lens 750 may have negative refractive power, a first surface of the fifth lens 750 may be convex, and a second surface of the fifth lens 750 may be concave. The sixth lens 760 may have positive refractive power, a first surface of the sixth lens 760 may be convex, and a second surface of the sixth lens 760 may be concave.

According to the seventh embodiment of the present disclosure, the second lens group G2 may include a D-cut lens. For example, the fourth lens 740 and the fifth lens 750 may each be provided as a D-cut lens.

Aspheric data for the individual lenses constituting the optical imaging system 700 according to the seventh embodiment of the present disclosure is shown in Table 14 below. According to the seventh embodiment, the first and second surfaces of the first lens 710 to the sixth lens 760 may all be aspherical.

TABLE 14

| Remark | S2 | S3 | S4 | S5 | S6 | S7 |
|---|---|---|---|---|---|---|
| K | −0.995 | 19.041 | 72.966 | −12.559 | 50.461 | 99.000 |
| A | −1.866E−04 | −1.684E−04 | 1.856E−07 | −6.134E−05 | 1.483E−04 | −1.585E−04 |
| B | −8.595E−06 | −2.323E−06 | −3.618E−06 | 2.798E−06 | 8.635E−06 | −4.796E−06 |
| C | −2.687E−07 | −1.287E−07 | −2.052E−07 | −3.776E−08 | 4.949E−08 | −1.869E−07 |
| D | 0.000E+00 | 0.000E+00 | 0.000E+00 | 0.000E+00 | 0.000E+00 | 0.000E+00 |
| E | 0.000E+00 | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

| Remark | S11 | S12 | S13 | S14 | S15 | S16 |
|---|---|---|---|---|---|---|
| K | −0.653 | 0.000 | −11.289 | −1.470 | −0.987 | −7.543 |
| A | −3.309E−01 | −5.260E−04 | −1.677E−04 | −2.889E−02 | 7.516E−04 | 1.194E−01 |
| B | 1.867E−01 | 1.490E−04 | −2.507E−05 | 1.262E−02 | 1.811E−04 | −1.035E−01 |
| C | −2.013E+00 | 1.228E−06 | 8.463E−08 | 1.944E−01 | 9.373E−05 | 1.238E−01 |
| D | 1.644E+01 | −1.853E−06 | −2.858E−07 | −8.296E−01 | 1.458E−05 | −1.811E−01 |
| E | −6.875E+01 | 0.000E+00 | 0.000E+00 | 2.005E+00 | −9.656E−07 | 3.128E−01 |
| F | 1.719E+02 | 0.000E+00 | 0.000E+00 | −2.928E+00 | −6.734E−07 | −4.383E−01 |
| G | −2.596E+02 | 0.000E+00 | 0.000E+00 | 2.579E+00 | −1.818E−07 | 3.822E−01 |
| H | 2.178E+02 | 0.000E+00 | 0.000E+00 | −1.265E+00 | 4.949E−08 | −1.770E−01 |
| J | −7.797E+01 | 0.000E+00 | 0.000E+00 | 2.652E−01 | −3.909E−10 | 3.284E−02 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Eighth Embodiment

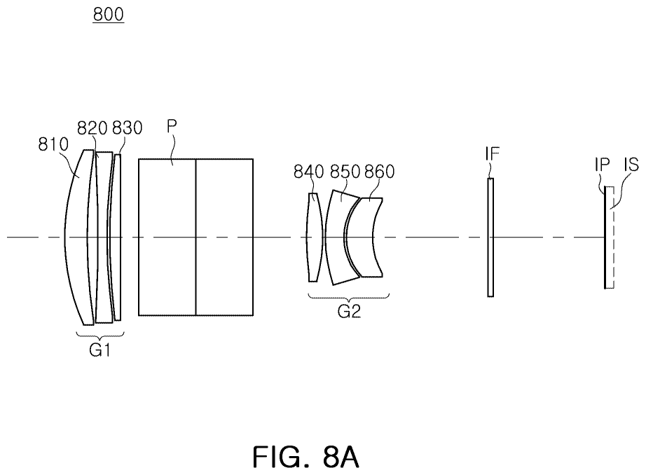

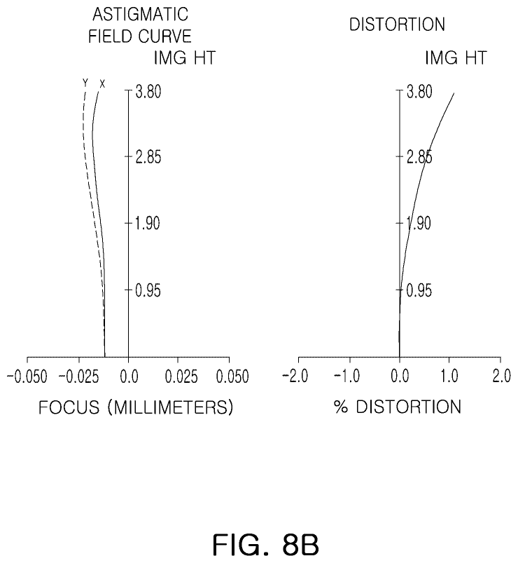

FIG. 8A is a schematic diagram of an optical imaging system according to an eighth embodiment of the present disclosure, and FIG. 8B is a graph illustrating the aberration characteristics of the optical imaging system of FIG. 8A.

An optical imaging system 800 according to the eighth embodiment of the present disclosure may include a first lens group G1, an optical path conversion member P, and a second lens group G2, arranged sequentially from the object side.

The first lens group G1 may include a first lens 810, a second lens 820, and a third lens 830, arranged sequentially from the object side. The second lens group G2 may include a fourth lens 840, a fifth lens 850, and a sixth lens 860.

In addition, the optical imaging system 800 may further include a filter IF and an image sensor IS having an imaging plane IP.

The optical path conversion member P may be disposed between the first lens group G1 and the second lens group G2, for example, between the third lens 830 and the fourth lens 840. For example, the optical path conversion member P may be configured as a prism including a reflective surface.

The physical and optical characteristics of the optical elements constituting the optical imaging system 800 according to the eighth embodiment of the present disclosure are as shown in Table 15 below.

TABLE 15

| | | | | | | Effective | Effective |
|---|---|---|---|---|---|---|---|
| Surface | | Radius of | Thickness/ | Refractive | Abbe | radius of | radius of |
| No. | Remark | curvature | distance | index | number | major axis | minor axis |
| Object | | Infinity | Infinity | | | | |
| S1 | | Infinity | 0.000 | | | | |
| S2 | First lens | 8.389 | 1.028 | 1.535 | 55.74 | 4.000 | 4.000 |
| S3 | | 26.132 | 0.430 | | | 3.896 | 3.896 |
| S4 | Second | −113.569 | 0.400 | 1.614 | 25.94 | 3.879 | 3.879 |
| | lens | | | | | | |
| S5 | | 20.724 | 0.180 | | | 3.769 | 3.769 |
| S6 | Third lens | 65.244 | 0.462 | 1.544 | 55.99 | 3.763 | 3.763 |
| S7 | | 297.119 | 0.800 | | | 3.728 | 3.728 |
| S8 | Prism | Infinity | 2.500 | 1.717 | 29.50 | 4.000 | 2.500 |
| S9 | | Infinity | 2.500 | 1.717 | 29.50 | 4.000 | 3.535 |
| S10 | | Infinity | 2.398 | | | 4.000 | 2.500 |
| S11 | Fourth | 10.661 | 0.730 | 1.535 | 55.74 | 2.451 | 2.000 |
| | lens | | | | | | |
| S12 | | −8.550 | 0.109 | | | 2.363 | 2.000 |
| S13 | Fifth lens | 5.305 | 0.811 | 1.614 | 25.94 | 2.202 | 2.000 |
| S14 | (Stop) | 1.967 | 0.113 | | | 1.810 | 1.810 |
| S15 | Sixth lens | 2.589 | 1.200 | 1.639 | 23.49 | 1.813 | 1.813 |
| S16 | | 3.686 | 5.085 | | | 1.728 | 1.728 |
| S17 | Filter | Infinity | 0.210 | 1.517 | 64.20 | | |
| S18 | | Infinity | 4.928 | 1.535 | 55.74 | | |
| S19 | Imaging | Infinity | 0.011 | | | | |
| | plane | | | | | | |

In the eighth embodiment of the present disclosure, the first lens 810 may have positive refractive power, a first surface of the first lens 810 may be convex, and a second surface of the first lens 810 may be concave. The second lens 820 may have negative refractive power, and both a first surface and a second surface of the second lens 820 may be concave. The third lens 830 may have positive refractive power, a first surface of the third lens 830 may be convex, and a second surface of the third lens 830 may be concave. The fourth lens 840 may have positive refractive power, and both a first surface and a second surface of the fourth lens 840 may be convex. The fifth lens 850 may have negative refractive power, a first surface of the fifth lens 850 may be convex, and a second surface of the fifth lens 850 may be concave. The sixth lens 860 may have positive refractive power, a first surface of the sixth lens 860 may be convex, and a second surface of the sixth lens 860 may be concave.

According to the eighth embodiment of the present disclosure, the second lens group G2 may include a D-cut lens. For example, the fourth lens 840 and the fifth lens 850 may each be provided as a D-cut lens.

Aspheric data for the individual lenses constituting the optical imaging system 800 according to the eighth embodiment of the present disclosure is shown in Table 16 below. According to the eighth embodiment, the first and second surfaces of the first lens 810 to the sixth lens 860 may all be aspherical.

TABLE 16

| Remark | S2 | S3 | S4 | S5 | S6 | S7 |
|---|---|---|---|---|---|---|
| K | −1.002 | 19.483 | 99.000 | −12.106 | 61.449 | −99.000 |
| A | −1.879E−04 | −1.701E−04 | −4.677E−06 | −5.665E−05 | 1.535E−04 | −1.651E−04 |
| B | −8.761E−06 | −2.168E−06 | −3.493E−06 | 2.844E−06 | 8.655E−06 | −4.933E−06 |
| C | −2.838E−07 | −1.213E−07 | −1.556E−07 | −5.433E−08 | 2.493E−08 | −1.560E−07 |
| D | 0.000E+00 | 0.000E+00 | 0.000E+00 | 0.000E+00 | 0.000E+00 | 0.000E+00 |
| E | 0.000E+00 | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 | 0.000E+00 |
| M | 0.000E+00 | 10.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

| Remark | S11 | S12 | S13 | S14 | S15 | S16 |
|---|---|---|---|---|---|---|
| K | −0.306 | 0.000 | −11.242 | −1.466 | −0.993 | −7.503 |
| A | −3.093E−01 | −5.438E−04 | −1.864E−04 | −2.604E−02 | 7.121E−04 | 1.193E−01 |
| B | −4.856E−03 | 1.481E−04 | −3.491E−05 | 1.570E−02 | 1.669E−04 | −1.101E−01 |
| C | −4.613E−01 | 1.903E−06 | −1.349E−06 | 1.325E−01 | 8.952E−05 | 1.723E−01 |
| D | 8.034E+00 | −1.612E−06 | 1.363E−07 | −5.335E−01 | 1.360E−05 | −3.631E−01 |
| E | −3.895E+01 | 0.000E+00 | 0.000E+00 | 1.225E+00 | −1.145E−06 | 6.923E−01 |
| F | 1.030E+02 | 0.000E+00 | 0.000E+00 | −1.720E+00 | −6.946E−07 | −8.945E−01 |
| G | −1.588E+02 | 0.000E+00 | 0.000E+00 | 1.469E+00 | −1.804E−07 | 6.955E−01 |
| H | 1.332E+02 | 0.000E+00 | 0.000E+00 | −7.032E−01 | 5.154E−08 | −2.907E−01 |
| J | −4.704E+01 | 0.000E+00 | 0.000E+00 | 1.444E−01 | −3.909E−10 | 4.968E−02 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

Table 17 illustrates other physical and optical parameters, including the focal lengths of individual lenses constituting the optical imaging systems according to the embodiments of the present disclosure. In Table 17, f3, f4, f5, and f6 are focal lengths of the third lens, the fourth lens, the fifth lens, and the sixth lens, respectively, BFL is a distance on the optical axis from an image-side surface of a rearmost lens (the sixth lens) to an image plane, and IMH (IMG HT) is a maximum effective image height of the optical imaging system and is equal to one half of a diagonal length of the effective imaging area of an imaging surface of the image sensor. Table 18 illustrates conditional expression data according to the embodiments of the present disclosure.

TABLE 17

| | Embodi- | Embodi- | Embodi- | Embodi- | Embodi- | Embodi- | Embodi- | mbodi- |
|---|---|---|---|---|---|---|---|---|
| Remark | ment 1 | ment 2 | ment 3 | ment 4 | ment 5 | ment 6 | ment 7 | ment 8 |
| f | 18.506 | 18.506 | 18.506 | 18.506 | 18.117 | 18.006 | 18.006 | 18.008 |
| f1 | 22.988 | 23.075 | 22.930 | 22.519 | 22.453 | 23.868 | 23.098 | 22.643 |
| f2 | −29.488 | −29.180 | −28.978 | −28.517 | −28.318 | −29.745 | −29.529 | −28.490 |
| f3 | 158.6358 | 166.178 | 164.298 | 197.628 | 200.852 | 200.854 | 179.309 | 153.570 |
| f4 | 8.670 | 8.663 | 8.617 | 8.601 | 8.461 | 8.800 | 8.832 | 8.990 |
| f5 | −6.795 | −6.866 | −6.788 | −6.805 | −6.806 | −5.936 | −5.686 | −5.607 |
| f6 | 17.994 | 18.491 | 17 .. 950 | 17.875 | 18.245 | 10.969 | 9.958 | 9.543 |
| fG1 | 56.979 | 59.793 | 59.319 | 61.414 | 61.878 | 65.744 | 58.937 | 56.838 |
| fG2 | 26.084 | 25.601 | 25.668 | 25.087 | 24.120 | 22.820 | 23.783 | 24.362 |
| h1 | 8.300 | 8.300 | 8.300 | 8.300 | 8.300 | 8.300 | 8.300 | 8.300 |
| h2 | 4.000 | 4.000 | 4.000 | 4.000 | 4.000 | 4.000 | 4.000 | 4.000 |
| OAL | 24.096 | 24.239 | 24.199 | 24.192 | 23.933 | 24.233 | 24.206 | 23.896 |
| BFL | 10.317 | 10.412 | 10.428 | 10.427 | 10.145 | 10.145 | 10.298 | 10.235 |
| dG1G2 | 8.100 | 8.100 | 8.100 | 8.100 | 8.100 | 8.494 | 8.494 | 8.198 |
| Fno | 3.274 | 3.321 | 3.320 | 3.324 | 3.252 | 3.246 | 3.257 | 3.255 |
| FOV | 21.628 | 21.609 | 21.620 | 21.599 | 22.041 | 22.255 | 22.253 | 22.226 |
| IMH | 3.575 | 3.575 | 3.575 | 3.575 | 3.575 | 3.575 | 3.575 | 3.575 |

TABLE 18

| | Embodi- | Embodi- | Embodi- | Embodi- | Embodi- | Embodi- | Embodi- | Embodi- |
|---|---|---|---|---|---|---|---|---|
| Remark | ment 1 | ment 2 | ment 3 | ment 4 | ment 5 | ment 6 | ment 7 | ment 8 |
| \|f/f1\| + \|f/f2\| | 1.433 | 1.436 | 1.446 | 1.471 | 1.447 | 1.360 | 1.389 | 1.427 |
| fG1/f | 3.079 | 3.231 | 3.205 | 3.319 | 3.415 | 3.651 | 3.273 | 3.156 |
| fG1/fG2 | 2.184 | 2.336 | 2.311 | 2.448 | 2.565 | 2.881 | 2.478 | 2.333 |
| h1/h2 | 2.075 | 2.075 | 2.075 | 2.075 | 2.075 | 2.075 | 2.075 | 2.075 |
| dG1G2/OAL | 0.336 | 0.334 | 0.425 | 0.335 | 0.338 | 0.438 | 0.351 | 0.343 |
| h2/Fno | 1.222 | 1.205 | 1.205 | 1.203 | 1.230 | 1.232 | 1.228 | 1.229 |

The optical imaging systems according to the embodiments of the present disclosure may enable high-quality and bright image capturing and further reduce a module height.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group, an optical path conversion member, and a second lens group, arranged sequentially from an object side,
wherein the first lens group comprises a plurality of lenses arranged along a first optical axis, and the second lens group comprises a plurality of lenses arranged along a second optical axis, and
wherein the optical imaging system satisfies conditional expression 3.0≤fG1/f≤4.0, where fG1 is a focal length of the first lens group and f is a focal length of the optical imaging system.

2. The optical imaging system of claim 1, wherein the optical imaging system satisfies conditional expression 2.0<fG1/fG2≤3.0, where fG1 is the focal length of the first lens group, and fG2 is a focal length of the second lens group.

3. The optical imaging system of claim 1, wherein the optical imaging system satisfies conditional expression 2≤h1/h2≤3, where h1 is a maximum height of the optical imaging system in a first optical axis direction and h2 is a maximum height of the second lens group in the first optical axis direction.

4. The optical imaging system of claim 1, wherein the optical imaging system satisfies conditional expression 0.5≤h2/Fno≤2 (unit: mm), where h2 is a maximum height of the second lens group in a first optical axis direction and Fno is an F-number of the optical imaging system.

5. The optical imaging system of claim 1, wherein the optical imaging system satisfies conditional expression 0.3≤dG1G2/OAL≤0.5, where dG1G2 is a distance on an optical axis between the first lens group and the second lens group, and OAL is a distance on the optical axis from an object-side surface of a frontmost lens to an image plane.

6. The optical imaging system of claim 1, wherein the first lens group and the second lens group comprise the same number of lenses.

7. The optical imaging system of claim 1, wherein the plurality of lenses arranged along the first optical axis and the plurality of lenses arranged along the second optical axis comprise:
a first lens, a second lens, a third lens, a fourth lens, a fifth lens, and a sixth lens arranged sequentially from the object side, and
wherein the optical path conversion member is disposed between the third lens and the fourth lens.

8. The optical imaging system of claim 7, wherein the optical imaging system satisfies conditional expression 0.5≤|f/f1|+|f/f2|≤2.0, where f is a focal length of the optical imaging system, f1 is a focal length of the first lens, and f2 is a focal length of the second lens.

9. The optical imaging system of claim 7, wherein the first lens has positive refractive power and a concave image-side surface.

10. The optical imaging system of claim 7, wherein the second lens has negative refractive power and a concave object-side surface.

11. The optical imaging system of claim 7, wherein the third lens has positive refractive power.

12. The optical imaging system of claim 7, wherein the fourth lens has positive refractive power, a convex object-side surface, and a convex image-side surface.

13. The optical imaging system of claim 7, wherein the fifth lens has negative refractive power and a convex object-side surface.

14. The optical imaging system of claim 7, wherein the sixth lens has positive refractive power.

15. The optical imaging system of claim 7, wherein the sixth lens has a convex object-side surface and a concave image-side surface.

16. The optical imaging system of claim 1, wherein the second lens group comprises a D-cut lens.
